(19) United States
(12) Patent Application Publication
(10) Pub. No.: US 2025/0066161 A1
(43) Pub. Date: Feb. 27, 2025

(54) APPARATUS, METHOD AND ELEVATOR SYSTEM FOR MONITORING STATUS OF CIRCUIT FOR LANDING DOOR AND CAR DOOR

(71) Applicant: Otis Elevator Company, Farmington, CT (US)

(72) Inventors: Xingzhong Sun, Hangzhou (CN); Shan Li, Hangzhou (CN); Weilin Dai, Hangzhou (CN)

(21) Appl. No.: 18/808,656

(22) Filed: Aug. 19, 2024

(30) Foreign Application Priority Data
Aug. 23, 2023 (CN) 202311069400.3

(51) Int. Cl. B66B 13/22

(52) U.S. Cl. CPC B66B 13/22

(57) ABSTRACT

A device for monitoring a state of a landing and car door circuit includes a selection unit configured to couple a first landing door lock switch and a second car door lock switch with a power supply in a first connection state, and to couple a second landing door lock switch and a first car door lock switch with the power supply in a second connection state; and a processing unit coupled with the selection unit and configured to cause the selection unit to be in the first connection state or the second connection state, and to determine whether functions of the first landing door lock switch, the second landing door lock switch, the first car door lock switch and the second car door lock switch are normal.

This application claims priority to Chinese Patent Application No. 202311069400.3, filed Aug. 23, 2023, and all the benefits accruing therefrom under 35 U.S.C. § 119, the contents of which in its entirety are herein incorporated by reference.

### TECHNICAL FIELD OF INVENTION

The present application relates to elevator technology and, in particular, to a device and method for monitoring a state of a landing and car door circuit, an elevator system comprising the device, and a non-transitory computer-readable storage medium for implementing the method.

### BACKGROUND OF THE INVENTION

An elevator system typically includes a car door lock switch and a plurality of landing door lock switches, wherein the car door lock switch is mounted at the car, the number of which usually depends on the number of car doors, and each landing door lock switch is mounted at a corresponding landing door. These switches are coupled together in series to form a landing and car door circuit. When the car is in motion, the car door lock switch and the landing door lock switches are in a closed state; when the car stops at a floor and the landing door and car door are opened, the car door lock switch and the landing door lock switch of the corresponding floor are in an opened state. However, if these door lock switches remain closed when the car stops at the floor or the landing and car doors are opened due to a malfunction, an erroneous elevator control signal may be generated, resulting in a safety accident. Therefore, it is necessary to provide a monitoring device in the elevator system to detect abnormalities in the functions of the door lock switches in a timely manner. However, existing monitoring devices require a large number of relays for the car door lock switch and landing door lock switches, which on the one hand leads to complex circuit structure and control logic as well as reduced reliability, and on the other hand increases the cost.

### SUMMARY OF THE INVENTION

According to an aspect of the present application, there is provided a device for monitoring a state of a landing and car door circuit, the landing and car door circuit comprising a first landing door lock switch, a second landing door lock switch, a first car door lock switch and a second car door lock switch sequentially coupled in series, the device comprising: a selecting unit configured to couple the first landing door lock switch and the second car door lock switch with a power supply in a first connection state, and to couple the second landing door lock switch and the first car door lock switch with the power supply in a second connection state; and a processing unit coupled with the selecting unit and configured to cause the selecting unit to be in the first connection state or the second connection state, and to determine whether functions of the first landing door lock switch, the second landing door lock switch, the first car door lock switch and the second car door lock switch are normal based on a first level signal at a common contact point of the first landing door lock switch and the second landing door lock switch and a second level signal at a common contact point of the first car door lock switch and the second car door lock switch in the first connection state and the second connection state when a landing door or a car door is opened.

Optionally, in the above device, the selecting unit comprises: a first contact switch coupled between the power supply and the second car door lock switch and configured to close in the first connection state and to open in the second connection state; and a second contact switch with linkage to the first contact switch, the second contact switch being coupled between the power supply and a common contact point of the second landing door lock switch and the first car door lock switch and configured to open in the first connection state and to close in the second connection state.

Further optionally, in the above device, the selecting unit further comprises a third contact switch with linkage to the first contact switch, the third contact switch is coupled between the power supply and the processing unit and configured to close in the first connection state and to open in the second connection state, the processing unit is configured to determine whether the selecting unit can function normally based on a level at the third contact switch in the first connection state.

Further optionally, in the above device, the processing unit is configured to determine whether the functions of the first landing door lock switch and the second car door lock switch are normal according to the following manner: determining that the function of the first landing door lock switch is abnormal if the first level signal is high in the first connection state, otherwise determining that the function of the first landing door lock switch is normal; and determining that the function of the second car door lock switch is abnormal if the second level signal is high in the first connection state, otherwise determining that the function of the second car door lock switch is normal.

Further optionally, in the above device, the processing unit is configured to determine whether the functions of the second landing door lock switch and the first car door lock switch are normal according to the following manner: causing the selecting unit into the second connection state if it is determined that the functions of the first landing door lock switch and the second car door lock switch are normal; determining that the function of the second landing door lock switch is abnormal if the first level signal is high in the second connection state, otherwise determining that the function of the second landing door lock switch is normal; and determining that the function of the first car door lock switch is abnormal if the second level signal is high in the second connection state, otherwise determining that the function of the first car door lock switch is normal.

According to another aspect of the present application, there is provided an elevator system comprising: a landing and car door circuit comprising a first landing door lock switch, a second landing door lock switch, a first car door lock switch and a second car door lock switch sequentially coupled in series; a safety device comprising: a selecting unit configured to couple the first landing door lock switch and the second car door lock switch with a power supply in a first connection state, and to couple the second landing door lock switch and the first car door lock switch with the power supply in a second connection state; and a processing unit coupled with the selecting unit and configured to cause the selecting unit to be in the first connection state or the second connection state, and to determine whether functions of the first landing door lock switch, the second landing door lock switch, the first car door lock switch and the second car door lock switch are normal based on a first level signal at a common contact point of the first landing door lock switch and the second landing door lock switch and a second level signal at a common contact point of the first car door lock switch and the second car door lock switch in the first connection state and the second connection state when a landing door or a car door is opened.

According to another aspect of the present application, there is provided a method for monitoring a state of a landing and car door circuit using the above device, comprising the following steps performed when a landing door or a car door is opened: determining whether functions of a first landing door lock switch and a second car door lock switch are normal based on a first level signal and a second level signal in a first connection state; causing a selecting unit into a second connection state if it is determined that the functions of the first landing door lock switch and the second car door lock switch are normal; determining whether functions of a second landing door lock switch and a first car door lock switch are normal based on the first level signal and the second level signal in the second connection state.

According to another aspect of the present application, there is provided a non-transitory computer-readable storage medium, the computer-readable storage medium having instructions stored therein which, when the instructions are executed by a microcontroller, cause the microcontroller to execute the above method.

### BRIEF DESCRIPTION OF THE DRAWINGS

The above and/or other aspects and advantages of the present application will be clearer and more easily understood from the following description of various aspects in conjunction with the accompanying drawings, in which the same or similar elements are denoted by the same reference numerals. The accompanying drawings include:

FIG. 1 is a schematic diagram of a device for monitoring a state of a landing and car door circuit in accordance with some embodiments of the present application.

FIGS. 2A and 2B are schematic diagrams of a connection relationship of the device shown in FIG. 1 in first and second connection states, respectively.

FIG. 3 is a schematic diagram of a device that may be used to realize a function of a selecting unit shown in FIG. 1.

FIG. 4 is a schematic diagram of a control device that may be used to realize a processing unit shown in FIG. 1.

FIG. 5 is a schematic flow diagram of a method for monitoring a state of a landing and car door circuit in accordance with some other embodiments of the present application.

### DETAILED DESCRIPTION OF THE INVENTION

The present application is described more fully below with reference to the accompanying drawings, in which illustrative embodiments of the application are illustrated. However, the present application may be implemented in different forms and should not be construed as limited to the embodiments presented herein. The presented embodiments are intended to make the disclosure herein comprehensive and complete, so as to more comprehensively convey the protection scope of the application to those skilled in the art.

In this specification, terms such as “comprising” and “including” mean that in addition to units and steps that are directly and clearly stated in the specification and claims, the technical solution of the application does not exclude the presence of other units and steps that are not directly and clearly stated in the specification and claims.

Unless otherwise specified, terms such as “first” and “second” do not indicate the order of the units in terms of time, space, size, etc., but are merely used to distinguish the units.

In this specification, “contact switch” refers to a switching element that utilizes conductive contacts to perform functions such as opening or closing a circuit, interrupting current, or causing current to flow to other circuits.

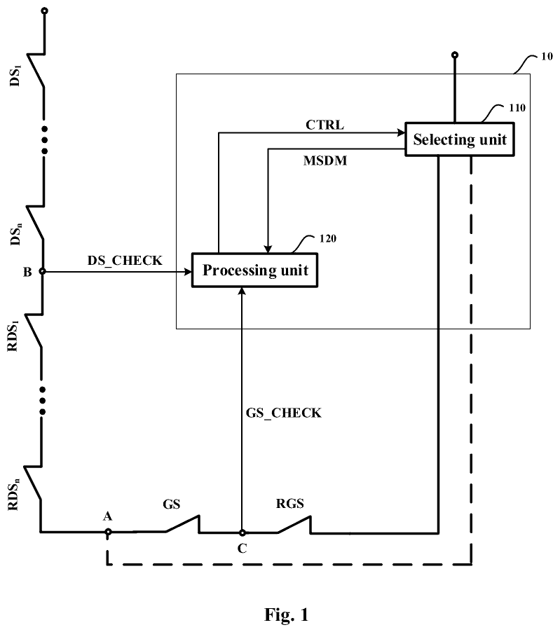

FIG. 1 is a schematic diagram of a device for monitoring a state of a landing and car door circuit in accordance with some embodiments of the present application. Referring to FIG. 1, a landing and car door circuit L being monitored includes first landing door lock switches DS1 to DSn, second landing door lock switches RDS1 to RDSn, a first car door lock switch GS and a second car door lock switch RGS, which are coupled together in series. In some examples, the first landing door lock switches DS1 to DSn are used as landing door lock switches equipped for front landing doors, the second landing door lock switches RDS1 to RDSn are used as landing door lock switches equipped for rear landing doors, the first car door lock switch GS is used as a car door lock switch equipped for a front car door, and the second car door lock switch RGS is used as a car door lock switch equipped for a rear car door.

It should be noted that the number of the first and second landing door lock switches usually depends on the number of floors, and the number of the car door lock switches depends on the number of car doors. It also should be noted that the order of the door lock switches in the landing and car door circuit L shown in FIG. 1 is only exemplary, and that the positions of the first landing door lock switches DS1 to DSn and the second landing door lock switches RDS1 to RDSn may be interchanged, and that the positions of the first car door lock switch GS and the second car door lock switch RGS may also be interchanged.

Continuing to refer to FIG. 1, a device 10 for monitoring a state of the landing and car door circuit includes a selecting unit 110 and a processing unit 120. The selecting unit 110 is connected to the landing and car door circuit L. In the example shown in FIG. 1, one end of the selecting unit 110 is coupled with a (ΔC or DC) power supply V, and the other end is selectively coupled with the second car door lock switch RGS (shown by a solid line), or coupled to a common contact point A between the second landing door lock switch RDSn and the first car door lock switch GS (shown by a dotted line).

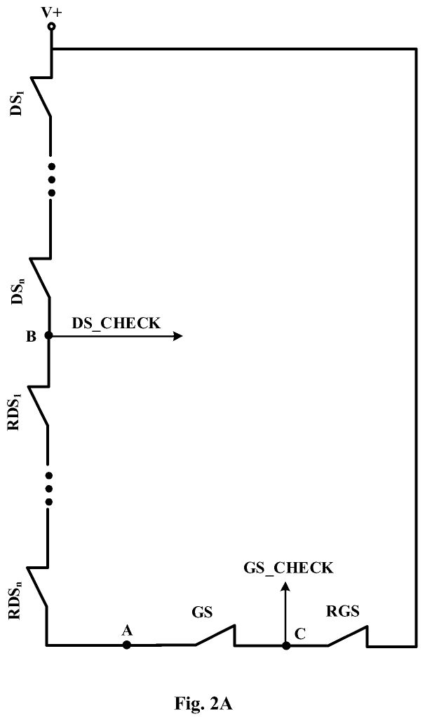

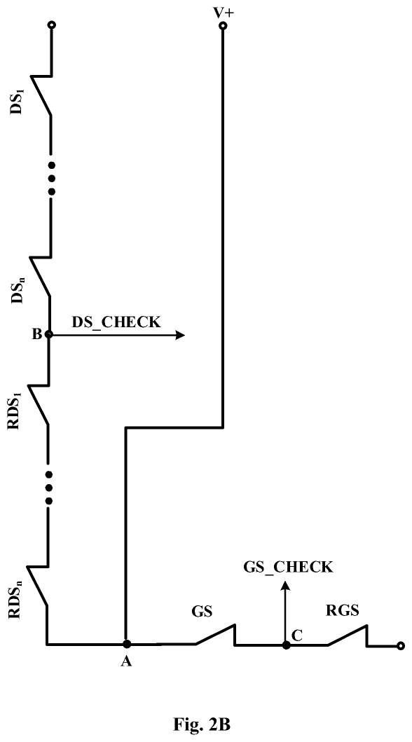

The selecting unit 110 has a first connection state and a second connection state, wherein in the first connection state, as shown in FIG. 2A, the selecting unit 110 couples the second car door lock switch RGS with the power supply V, such that the first landing door lock switch DS1 and the second car door lock switch RGS are coupled to, or connected in parallel to, the power supply V; in the second connection state, as shown in FIG. 2B, the selecting unit 110 couples the power supply V with the common contact point A of the second landing door lock switch RDSn and the first car door lock switch GS, i.e., such that the second landing door lock switch RDSn and the first car door lock switch GS are connected in parallel to the power supply V.

The processing unit 120 is coupled with the selecting unit 110 and configured to control a connection state in which the selecting unit 110 is in when a car stops at a floor or when a landing door and a car door are opened, e.g., as shown in FIG. 1, the processing unit 120 controls the selecting unit 110 by means of a control signal CTRL so that the selecting unit 110 is in the first connection state or the second connection state. On the other hand, the processing unit 120 also obtains a level signal DS_CHECK from a common contact point B between the first landing door lock switches DS1 to DSn and the second landing door lock switches RDS1 to RDSn (i.e., between the landing door lock switch DSn and the landing door lock switch RDS1), obtains a level signal GS_CHECK from a common contact point C between the first car door lock switch GS and the second car door lock switch RGS, and determines whether functions of the first landing door lock switches DS1 to DSn, the second landing door lock switches RDS1 to RDSn, the first car door lock switch GS and the second car door lock switch RGS are normal based on levels of the level signal DS_CHECK and the level signal GS_CHECK.

The judgment logic for determining whether the functions of the door lock switches are normal or not is described below with the aid of FIGS. 2A and 2B.

In the first connection state shown in FIG. 2A, the first landing door lock switch DS1 and the second car door lock switch RGS are coupled to or connected in parallel to the power supply V. If the car stops at a floor or the landing door and the car door are opened, the car door lock switch and the landing door lock switch of the corresponding floor should be in an opened state. In this case, the landing and car door circuit L is in an opened state, thus the level signal DS_CHECK and the level signal GS_CHECK are in a low level state. If the first landing door lock switch of the corresponding floor (assumed to be the first landing door lock switch DSi, 1≤i≤n) fails to open normally, the level signal DS_CHECK will be in a high level state, and therefore it can be judged that the function of the first landing door lock switch DSi is abnormal. Similarly, if the second car door lock switch RGS fails to open normally, the level signal GS_CHECK will be in a high level state, and therefore it can be judged that the function of the second car door lock switch RGS is abnormal.

In the second connection state shown in FIG. 2B, the second landing door lock switch RDSn and the first car door lock switch GS are connected in parallel to the power supply V via the common contact point A. If the car stops at a floor or the landing door and the car door are opened, the car door lock switch and the landing door lock switch of the corresponding floor should be in an opened state. In this case, the landing and car door circuit L is in an opened state, thus the level signal DS_CHECK and the level signal GS_CHECK are in a low level state. If the second landing door lock switch of the corresponding floor (assumed to be the second landing door lock switch RDSj, 1≤j≤n) fails to open normally, the level signal DS_CHECK will be in a high level state, and therefore it can be judged that the function of the second landing door lock switch RDSj is abnormal. Similarly, if the first car door lock switch GS fails to open normally, the level signal GS_CHECK will be in a high level state, and therefore it can be judged that the function of the first car door lock switch GS is abnormal.

In some embodiments, the processing unit 120 is also configured to have a detection function for the selecting unit 110. For example, as shown in FIG. 1, the processing unit 120 may judge whether the function of the selecting unit is normal based on a state signal MSDM from the selecting unit 110.

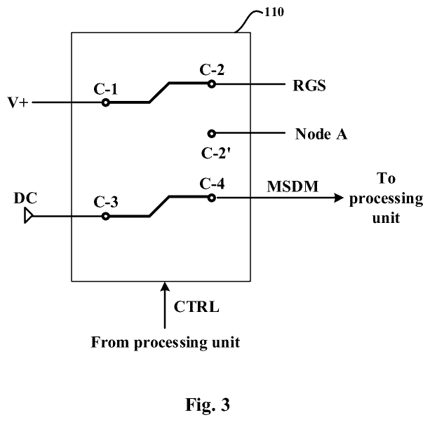

The selecting unit 110 shown in FIG. 1 may be realized using a relay comprising a plurality of linked contact switches. FIG. 3 is a schematic diagram of a device (e.g., a relay) that may be used to realize the above-described function of the selecting unit.

Referring to FIG. 3, the selecting unit 110 comprises a first contact switch (which comprises contacts C-1 and C-2), a second contact switch (which comprises contacts C-1 and C-2′), and a third contact switch (which comprises contacts C3 and C4). One contact C-1 of the first contact switch and the second contact switch is coupled with the power supply V, the other contact C-2 of the first contact switch is coupled to the second car door lock switch RGS, and the other contact C-2′ of the second contact switch is coupled to the common contact point A of the second landing door lock switch RDSn and the first car door lock switch GS.

The first contact switch is configured to be closed in the first connection state and opened in the second connection state such that the second car door lock switch RGS is coupled to the power supply V in the first connection state. Exemplarily, the first contact switch may be a normally closed contact switch.

The second contact switch is configured to be with linkage to the first contact switch, i.e., to be opened in the first connection state and closed in the second connection state such that the common contact point A of the second landing door lock switch RDSn and the first car door lock switch GS is coupled to the power supply V in the second connection state. Exemplarily, the second contact switch is a normally opened contact switch.

One contact C-3 of the third contact switch is coupled with a DC power supply DC and the other contact C4 is coupled to the processing unit 120. The third contact switch is configured to be with linkage to the first contact switch, i.e., to be closed in the first connection state and opened in the second connection state. Exemplarily, the third contact switch may be a normally closed contact switch.

In the first connection state, the processing unit 120 may judge whether the function of the selecting unit 110 is normal based on a level signal MSDM at the contact C4. Specifically, in the first connection state, if the level signal MSDM is in a high level state, the function of the selecting unit 110 may be judged to be normal, otherwise, the function of the selecting unit 110 may be judged to be abnormal.

Continuing to refer to FIG. 3, the processing unit 120 may control the close-open of the second contact switch by means of the control signal CTRL, and control the close-open of the first contact switch and the third contact switch with the aid of the linking mechanism. Exemplarily, when the processing unit 120 applies the control signal CTRL at a control terminal of the relay, the second contact switch as a normally open contact switch is engaged and causes the first contact switch and the third contact switch as a normally closed contact switch to be opened.

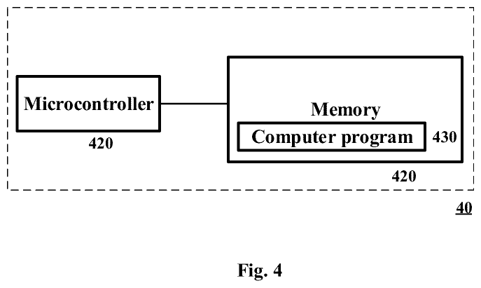

The processing unit 120 shown in FIG. 1 may be realized using a control device shown in FIG. 4. As shown in FIG. 4, a control device 40 comprises a memory 410 (e.g., a non-volatile memory such as a flash memory, a ROM, a hard disk drive, a magnetic disk, an optical disc, etc.), a microcontroller 420, and a computer program 430 stored on the memory 410 and runnable on the microcontroller 420.

The microcontroller 420 of FIG. 4 may include a port group to communicate with an external device. Exemplarily, the above port group comprises, for example, a port coupled to the common contact points B and C to obtain the level signals DS_CHECK and GS_CHECK, a port coupled with the control terminal of the selecting unit 110 to apply the control signal CTRL, a port coupled with a state output terminal of the selecting unit 110 to receive the state signal MSDM, and the like.

In the control device shown in FIG. 4, the memory 410 stores the computer program 430 executable by the microcontroller 420. The microcontroller 420 may be configured to execute the computer program 430 to implement various functions of the processing unit described above (including, for example, but not limited to, control of the connection state of the selecting unit, judgment of whether the functions of the landing door lock switch and the car door lock switch are normal or not, and judgment of whether the function of the selecting unit is normal or not, etc.).

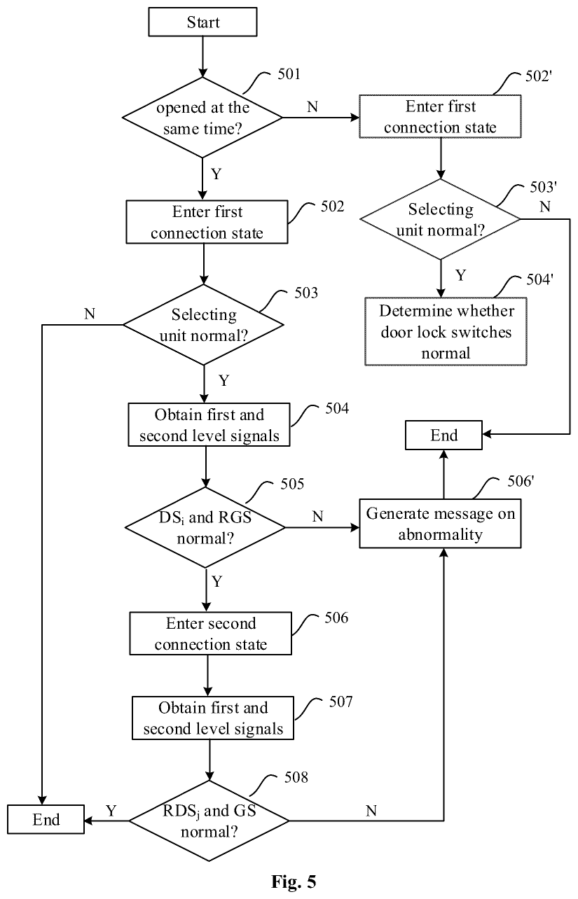

FIG. 5 is a schematic flow diagram of a method for monitoring a state of a landing and car door circuit in accordance with some other embodiments of the present application. Exemplarily, the method shown in FIG. 5 is realized using the device shown in FIG. 1.

The method shown in FIG. 5 includes the following steps:

Step 501: Determining whether the landing door and the car door are opened at the same time on the same floor, and if they are opened at the same time, proceed to step 502, otherwise proceed to step 502′.

Step 502: Under the control of the processing unit 120, the selecting unit 110 enters the first connection state. Exemplarily, the processing unit 120 causes the selecting unit 110 into the first connection state, for example, by de-activating the control signal CTRL.

Step 503: The processing unit 120 judges whether the function of the selecting unit 110 is normal, and if normal, proceed to step 504, otherwise exit the processing flow.

Step 504: The processing unit 120 obtains a first level signal and a second level signal in the first connection state.

Step 505: The processing unit 120 judges whether the functions of the first landing door lock switch (e.g., DSi) and the second car door lock switch RGS are normal based on the first level signal and the second level signal obtained at step 504. If the functions are judged to be normal, proceed to step 506, otherwise proceed to step 506′.

Step 506: Under the control of the processing unit 120, the selecting unit 110 enters the second connection state.

Step 506′: The processing unit 120 generates a message that the function of the first landing door lock switch or the second car door lock switch is abnormal and subsequently exits the processing flow.

Step 507: The processing unit 120 obtains a first level signal and a second level signal in the second connection state.

Step 508: The processing unit 120 judges whether the functions of the second landing door lock switch (e.g., RDSj) and the first car door lock switch GS are normal based on the first level signal and the second level signal obtained at step 507. If the functions are judged to be normal, end the processing flow, otherwise proceed to step 506′.

In steps 505 and 508, the specific judgment logic for determining whether the functions of the door lock switches are normal or not has been described in detail above, and will not be repeated here.

Another branch after step 501 is described below.

Step 502′: Under the control of the processing unit 120, the selecting unit 110 enters the first connection state.

Step 503′: The processing unit 120 judges whether the function of the selecting unit 110 is normal, and if normal, proceed to step 504′, otherwise exit the processing flow.

Step 504′: The processing unit 120 determines whether the functions of the first landing door lock switch DSi and the first car door lock switch GS are normal or not by the first level signal and the second level signal in the first connection state, based on a judgment logic for a single-door-opening scenario (e.g., only one of the car doors of the car and the corresponding landing door are open).

According to another aspect of the present application, there is provided a non-transitory computer-readable storage medium on which is stored a computer program which, when executed by a microcontroller, realizes the method described above with the aid of the figures.

The computer-readable storage medium referred to in the application includes various types of computer storage media, and may be any available medium that may be accessed by a general-purpose or special-purpose computer. For example, the computer-readable storage medium may include RAM, ROM, EPROM, E2PROM, registers, hard disks, removable disks, CD-ROM or other optical disc storage, magnetic disk storage or other magnetic storage devices, or any other transitory or non-transitory medium that may be used to carry or store a desired program code unit in the form of instructions or data structures and that may be accessed by a general-purpose or special-purpose computer or a general-purpose or special-purpose processor. Disks, as used herein, typically reproduce data magnetically, while discs use lasers to reproduce data optically. The above combination should also be included in the protection scope of the computer-readable storage medium. An exemplary storage medium is coupled to the processor such that the processor can read and write information from and to the storage medium. In the alternative, the storage medium may be integrated into the processor. The processor and the storage medium may reside in the ASIC. The ASIC may reside in the user terminal. In the alternative, the processor and the storage medium may reside as discrete components in the user terminal.

Those skilled in the art will appreciate that the various illustrative logical blocks, modules, circuits, and algorithm steps described herein may be implemented as electronic hardware, computer software, or combinations of both.

To demonstrate this interchangeability between the hardware and software, various illustrative components, blocks, modules, circuits, and steps have been described above generally in terms of their functionality. Whether such functionality is implemented in hardware or software depends on the particular application and design constraints imposed on the overall system. Those skilled in the art may implement the described functionality in changing ways for the particular application. However, such implementation decisions should not be interpreted as causing a departure from the scope of the present application.

Although only a few of the specific embodiments of the present application have been described, those skilled in the art will recognize that the present application may be embodied in many other forms without departing from the spirit and scope thereof. Accordingly, the examples and implementations shown are to be regarded as illustrative and not restrictive, and various modifications and substitutions may be covered by the application without departing from the spirit and scope of the application as defined by the appended claims.

The embodiments and examples presented herein are provided to best illustrate embodiments in accordance with the present technology and its particular application, and to thereby enable those skilled in the art to implement and use the present application. However, those skilled in the art will appreciate that the above description and examples are provided for convenience of illustration and example only. The presented description is not intended to cover every aspect of the application or to limit the application to the precise form disclosed.

What is claimed is:

1. A device for monitoring a state of a landing and car door circuit, the landing and car door circuit comprising a first landing door lock switch, a second landing door lock switch, a first car door lock switch and a second car door lock switch sequentially coupled in series, the device comprising:
a selecting unit configured to couple the first landing door lock switch and the second car door lock switch with a power supply in a first connection state, and to couple the second landing door lock switch and the first car door lock switch with the power supply in a second connection state; and
a processing unit coupled with the selecting unit and configured to cause the selecting unit to be in the first connection state or the second connection state, and to determine whether functions of the first landing door lock switch, the second landing door lock switch, the first car door lock switch and the second car door lock switch are normal based on a first level signal at a common contact point of the first landing door lock switch and the second landing door lock switch and a second level signal at a common contact point of the first car door lock switch and the second car door lock switch in the first connection state and the second connection state when a landing door or a car door is opened.

2. The device of claim 1, wherein the selecting unit comprises:
a first contact switch coupled between the power supply and the second car door lock switch and configured to close in the first connection state and to open in the second connection state; and
a second contact switch with linkage to the first contact switch, the second contact switch being coupled between the power supply and a common contact point of the second landing door lock switch and the first car door lock switch and configured to open in the first connection state and to close in the second connection state.

3. The device of claim 2, wherein the selecting unit further comprises a third contact switch with linkage to the first contact switch, the third contact switch being coupled between the power supply and the processing unit and configured to close in the first connection state and to open in the second connection state, the processing unit being configured to determine whether the selecting unit can function normally based on a level at the third contact switch in the first connection state.

4. The device of claim 2, wherein the processing unit is configured to determine whether the functions of the first landing door lock switch and the second car door lock switch are normal according to the following manner:
determining that the function of the first landing door lock switch is abnormal if the first level signal is high in the first connection state, otherwise determining that the function of the first landing door lock switch is normal; and
determining that the function of the second car door lock switch is abnormal if the second level signal is high in the first connection state, otherwise determining that the function of the second car door lock switch is normal.

5. The device of claim 4, wherein the processing unit is configured to determine whether the functions of the second landing door lock switch and the first car door lock switch are normal according to the following manner:
causing the selecting unit into the second connection state if it is determined that the functions of the first landing door lock switch and the second car door lock switch are normal;
determining that the function of the second landing door lock switch is abnormal if the first level signal is high in the second connection state, otherwise determining that the function of the second landing door lock switch is normal; and
determining that the function of the first car door lock switch is abnormal if the second level signal is high in the second connection state, otherwise determining that the function of the first car door lock switch is normal.

6. An elevator system comprising:
a landing and car door circuit comprising a first landing door lock switch, a second landing door lock switch, a first car door lock switch and a second car door lock switch sequentially coupled in series;
a safety device comprising:
a selecting unit configured to couple the first landing door lock switch and the second car door lock switch with a power supply in a first connection state, and to couple the second landing door lock switch and the first car door lock switch with the power supply in a second connection state; and
a processing unit coupled with the selecting unit and configured to cause the selecting unit to be in the first connection state or the second connection state, and to determine whether functions of the first landing door lock switch, the second landing door lock switch, the first car door lock switch and the second car door lock switch are normal based on a first level signal at a common contact point of the first landing door lock switch and the second landing door lock switch and a second level signal at a common contact point of the first car door lock switch and the second car door lock switch in the first connection state and the second connection state when a landing door or a car door is opened.

7. The elevator system of claim 6, wherein the selecting unit comprises:
a first contact switch coupled between the power supply and the second car door lock switch and configured to close in the first connection state and to open in the second connection state; and
a second contact switch with linkage to the first contact switch, the second contact switch being coupled between the power supply and a common contact point of the second landing door lock switch and the first car door lock switch and configured to open in the first connection state and to close in the second connection state.

8. The elevator system of claim 7, wherein the selecting unit further comprises a third contact switch with linkage to the first contact switch, the third contact switch is coupled between the power supply and the processing unit and configured to close in the first connection state and to open in the second connection state, the processing unit is configured to determine whether the selecting unit can function normally based on a level at the third contact switch in the first connection state.

9. The elevator system of claim 6, wherein the processing unit is configured to determine whether the functions of the first landing door lock switch and the second car door lock switch are normal according to the following manner:
determining that the function of the first landing door lock switch is abnormal if the first level signal is high in the first connection state, otherwise determining that the function of the first landing door lock switch is normal; and
determining that the function of the second car door lock switch is abnormal if the second level signal is high in the first connection state, otherwise determining that the function of the second car door lock switch is normal.

10. The elevator system of claim 9, wherein the processing unit is configured to determine whether the functions of the second landing door lock switch and the first car door lock switch are normal according to the following manner:
causing the selecting unit into the second connection state if it is determined that the functions of the first landing door lock switch and the second car door lock switch are normal;
determining that the function of the second landing door lock switch is abnormal if the first level signal is high in the second connection state, otherwise determining that the function of the second landing door lock switch is normal; and
determining that the function of the first car door lock switch is abnormal if the second level signal is high in the second connection state, otherwise determining that the function of the first car door lock switch is normal.

11. A method for monitoring a state of a landing and car door circuit using the device of claim 1, comprising the following steps performed when a landing door or a car door is opened:
determining whether functions of a first landing door lock switch and a second car door lock switch are normal based on a first level signal and a second level signal in a first connection state;
causing a selecting unit into a second connection state if it is determined that the functions of the first landing door lock switch and the second car door lock switch are normal;
determining whether functions of a second landing door lock switch and a first car door lock switch are normal based on the first level signal and the second level signal in the second connection state.

12. The method of claim 11, wherein the selecting unit comprises: a first contact switch coupled between the power supply and the second car door lock switch and configured to close in the first connection state and to open in the second connection state; and a second contact switch with linkage to the first contact switch, the second contact switch being coupled between the power supply and a common contact point of the second landing door lock switch and the first car door lock switch and configured to open in the first connection state and to close in the second connection state; a third contact switch with linkage to the first contact switch, the third contact switch being coupled between the power supply and the processing unit and configured to close in the first connection state and to open in the second connection state,
the method further comprises: determining whether the selecting unit can function normally based on a level at the third contact switch in the first connection state.

13. A non-transitory computer-readable storage medium, the non-transitory computer-readable storage medium having instructions stored therein which, when the instructions are executed by a microcontroller, cause the microcontroller to execute the method of claim 11.
